(19) United States
(12) Patent Application Publication
(10) Pub. No.: US 2024/0167924 A1
(43) Pub. Date: May 23, 2024

(54) Chemical Systems and Methods

(71) Applicant: Kanomax FMT, Inc., White Bear Lake, MN (US)

(72) Inventors: Derek OBERREIT, Roseville, MN (US); Siqin HE, St Paul, MN (US)

(73) Assignee: Kanomaz FMT, Inc., White Bear Lake, MN (US)

(21) Appl. No.: 18/550,249

(22) PCT Filed: Mar. 14, 2022
(86) PCT No.: PCT/US2022/020175

§ 371 Date: Sep. 12, 2023

Related U.S. Application Data
(60) Provisional application No. 63/160,384, filed on Mar. 12, 2021.
(60) Provisional application No. 63/160,401, filed on Mar. 12, 2021.
(60) Provisional application No. 63/160,425, filed on Mar. 12, 2021.

(51) Int. Cl. G01N 1/38; G01N 1/44; G01N 15/06

(52) U.S. Cl. CPC G01N 1/38; G01N 1/44; G01N 15/06

(57) ABSTRACT

A method and an apparatus for conditioning an analyte for measurement. The method may comprise the steps of: providing an analyte; collecting a sample of the analyte; conditioning the sample of analyte; and supplying the conditioned analyte to an analytical apparatus. The apparatus for conditioning an analyte for measurement may comprise: a reservoir for receiving and holding an analyte; an analyte collector communicatively connected to the reservoir; an analyte conditioner communicatively connected to the analyte collector, and an analytical apparatus communicatively connected to the analyte conditioner.

### BACKGROUND OF THE INVENTION

### 1. Field of the Invention

The present invention relates, generally, to chemical systems, apparatus, and methods. Particularly, the invention firstly relates to online measurement of chemicals with emphasis on (1) sample input (via a pressure vessel or pump), (2) direct (capillary) or regulated (flow or pressure) processing, and (3) batch or continuous processing. Secondly, the invention relates to on-line analytical measurement of particle size distribution, particle number concentration, other properties of colloids, including control of the pH of a diluted sample in such on-line systems, by adjusting the pH of the diluent. Thirdly, the invention relates to measurement of the concentration of particles in high purity liquids, including the net contribution of High Molecular Weight (HMW) Organic Particles on Total Particles in High Purity Liquids.

### 2. Background Information

Existing technology in this field is believed to have significant limitations and shortcomings. For this and other reasons, a need exists for the present invention.

All US patents and patent applications, and all other published documents mentioned anywhere in this application are incorporated by reference in their entirety.

### BRIEF SUMMARY OF THE INVENTION

The invention provides several chemical systems, apparatus and methods. The systems, apparatus and methods are practical, reliable, accurate and efficient, and are believed to fulfill a need and to constitute an improvement over the background technology. The invention provides:
(1) pressure controlled sample delivery systems and method, which are particularly useful for to process chemicals and slurry distribution systems;
(2) on-line, colloid property measurement, with improved control of diluent pH; and
(3) High Molecular Weight Organic (HMWO) Particle Processing including a housing having a sample inlet, a UV lamp, a quartz sleeve, and an outlet adapted to be connected to a Particle Detector.

1. System and Method for Measuring Chemicals

In this First Set of Systems, Apparatus and Methods, invention provides online measurement of chemicals with emphasis on (1) sample input (via a pressure vessel or pump), (2) direct (capillary) or regulated (flow or pressure) processing, and (3) batch or continuous processing.

This system and method permit on-line dilution of chemicals with a diluent for analysis by analytical instrumentation. The system and method also permits introducing chemicals to a dilution module and for regulating the dilution ratio between chemical and diluent. The system and method further permits calculating particle concentrations in sample chemicals.

In one aspect, a method is provided for conditioning an analyte for measurement, comprising the steps of:
providing an analyte;
collecting a sample of the analyte;
conditioning the sample of analyte; and
supplying the conditioned analyte to an analytical apparatus.

In another aspect, an apparatus is provided for conditioning an analyte for measurement by analytical instrumentation, comprising
a reservoir for receiving and holding an analyte;
an analyte collector communicatively connected to the reservoir;
an analyte conditioner communicatively connected to the analyte collector; and
an analytical apparatus communicatively connected to the analyte conditioner.

2. System and Method for Controlling pH of Liquids Used to Dilute Colloidal Particle Samples.

In the Second Set, an aspect of the invention is an apparatus comprising a Sample Input connected to a Particle Counter having an Ultra Pure (or Ultra-Pure) Water (UPW) Supply and an interconnected Dilution Module, an Acid/Base Supply connected to the dilution module, and a Control System.

The system, apparatus, and method provide improved quality monitoring of ultrapure liquids. This technology is useful in the semiconductor manufacture industry, the pharmaceutical industry, aerosol research, as well as other industries and fields.

3. Method and System for Measuring Net Contribution of High Molecular Weight Organic Particles on Total Particles in High Purity Liquids.

In this Third Set, an aspect is a HMWO Particle Processor including a housing having a sample inlet, a UV lamp, a quartz sleeve, and an outlet adapted to be connected to a Particle Detector. The processor is useful in the semiconductor manufacture industry, the pharmaceutical industry, aerosol research, as well as other industries and fields.

The aspects, features, advantages, benefits and objects of the invention will become clear to those skilled in the art by reference to the following description, claims and drawings.

### BRIEF DESCRIPTION OF THE SEVERAL VIEWS OF THE DRAWING

FIG. 1 shows an embodiment of the First Set of Systems and Methods For Measuring Chemicals of the Invention, whereby a sample can be obtained for measurement via a pressure vessel or a pump.

FIG. 2 shows an embodiment of the system, whereby a sample can be obtained online directly (capillary) or online regulated (flow or pressure).

FIG. 3 shows an embodiment of the system of the invention, whereby an online chamber can be operated in both batch and continuous modes.

FIG. 4 is a schematic diagram of an embodiment of an IPA sample delivery arrangement with pressure conditioning.

FIG. 5 is a first longitudinal crossectional view of an embodiment of an NPN mixer.

FIG. 6 is a second longitudinal crossectional view of the NPN mixer.

FIG. 7 is graph showing the effect of pH on the volumetric aerosolization rate of an aerosolizer.

FIG. 8 is a graph showing the effect of pH on measure size distributions.

FIG. 9 is a graph showing the effect of pH on particle sizing systems size distributions.

FIG. 10 shows an embodiment of the Second Set of systems of the invention for Measuring Net Contribution of High Molecular Weight Organic Particles on Total Particles in High Purity Liquids.

FIG. 11 show an embodiment of the Third Set of systems of the invention for Controlling pH of Liquids Used to Dilute Colloidal Particle Samples.

### DETAILED DESCRIPTION

The description that follows describes, illustrates and exemplifies one or more embodiments of the system and method for measuring chemicals of the present invention. This description is not provided to limit the disclosure to the embodiments described herein, but rather to explain and teach various principles to enable one of ordinary skill in the art to understand these principles and, with that understanding, be able to apply them to practice not only the embodiments described herein, but also other embodiments that may come to mind in accordance with these principles. The scope of the instant disclosure is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers in cases where such labeling facilitates a more clear description. Additionally, the drawings set forth herein are not necessarily drawn to scale, and in some instances proportions may have been exaggerated to more clearly depict certain features.

1. System and Method for Measuring Chemicals

The invention firstly provides a chemical measurement system, apparatus and method. The system and method permit measurement of various properties of chemicals, such as particle size distribution and particle number concentration. The system and method permit on-line dilution of chemicals with a diluent for analysis by analytical instrumentation. An example of a diluent is Ultra-Pure Water (UPW). Water-miscible chemicals can be diluted with UPW. The invention further provides a system and method of introducing chemicals to a dilution module and for regulating the dilution ratio between chemical and diluent.

In a preferred embodiment, the system and method permit conditioning of an analyte for measurement by an analytical instrument or instrumentation. The analyte may be a liquid and may be of high purity. The a pressure of the analyte may be regulated or conditioned to a desired value. Pressure regulation may be by means of a secondary fluid. Alternatively, pressure regulation may be by way of mechanical displacement. When regulation is by way of a secondary fluid, such fluid may be separated from the analyte, for example by a membrane. Alternatively, the secondary fluid may be in contact with the analyte. In addition to or independently of pressure regulation, the volumetric flow of analyte may be regulated or conditioned to a desired value. One means of flow regulation is by means of a flow restrictor, such as a capillary tube, an orifice, or by the introduction of a secondary fluid to the flow restrictor. The relationship of pressure and volumetric flow may be known by calibration or calculation. Lastly, the temperature of the analyte may be regulated or conditioned, for example by controlling the temperature of the restrictor. The temperature of the restrictor is measured, and volumetric flow, in for example a tube, may be corrected for temperature effects by calibration or calculation.

The system and method collect an analyte and sample it, preferably in an automated batch fashion, although collection may be done manually. The system has a reservoir. In one embodiment, analyte sample is collected by a positive displacement pump. The pump may be syringe type or peristaltic type. In another embodiment, the sample is collected from a pressurized conduit. The sample may be completely consumed during analysis. If not, excess sample may be discarded prior to subsequent collection. Discard may be by way of gravity, positive displacement pumping, or via a pressurized secondary fluid.

Analyte in the reservoir may be sampled continuously. Continuous sampling may be achieved by a positive displacement pump, which may be configured in parallel or singularly. Parallel arrangement positive displacement may be via piston type pump or a diaphragm type pump. Singular pumping is preferably via a peristaltic pump. The analyte may be pressurized at or above a required sample pressure. The analyte may be supplied from a pressurized transport conduit connected to an analyte distribution system. The analyte may alternatively be transferred to the measurement device using a sample conduit branched from the analyte transport conduit. When pressurized in the principal conduit to a required pressure, the pressure may be controlled or regulated by a liquid pressure regulator, by a secondary fluid, or by a flow restrictor. In the case of a liquid pressure regulator, the regulator pressure may be manually set or set by a pressurized pilot gas pressure. The pilot gas pressure may be modulated to achieve the pressure set point. Alternatively, the pressure of the analyte may be measured using a pressure transducer. Finally, feedback of the pressure transducer may be used to control the pilot gas pressure. In the case of a secondary fluid, the analyte is supplied to a pressurized chamber and may be sampled from a weir or sampled from the chamber. Lastly, the analyte transport conduit may return un-sampled analyte to the analyte distribution system.

Analyte may be supplied to the analytical instrumentation at full strength or diluted. One dilution embodiment is with a secondary liquid with volumetric flow greater than the analyte volumetric flow. Dilution may be used to reduce the analyte concentration, to modify analyte properties, to introduce a secondary material to facilitate measurement, or to reduce interference on measurement due to undissolved material in the analyte. In the case of reduction of analyte concentration, lowering the concentration is useful due to the dynamic range of the instrumentation, or due analyte concentration for chemical compatibility. In the case of modifying analyte properties, one such property is pH. The pH of the secondary fluid may be monitored and controlled. Or the pH of the secondary fluid plus the analyte may be monitored and controlled. Another property is temperature. In the case of introduction of a secondary liquid, such secondary liquid may be introduced at a volumetric flow less than the volumetric flow of the analyte. The secondary liquid may be mixed with analyte using a helical mixer, for example to minimize dead volume. The secondary liquid may be used to calibrate the measurement instrument. The secondary liquid may also be used to modify the property of the analyte, such as pH, temperature, or viscosity. Where the property is pH and/or temperature, the volumetric rate of the secondary fluid is modulated. The pH or temperature of the mixture is monitored and recorded. The measured pH value is used to control the dispense rate of the secondary fluid, as a characterization parameter of the analyte, to enhance the functional properties of the analyte, or to simulate practical application scenarios of the analyte. The secondary fluid may also be introduced to the instrumentation between samplings of the analyte to facilitate performance stabilization, to restore the pre-sampling condition of the instrumentation, to minimize cross contamination, or to adjust the performance characteristics of the instrumentation.

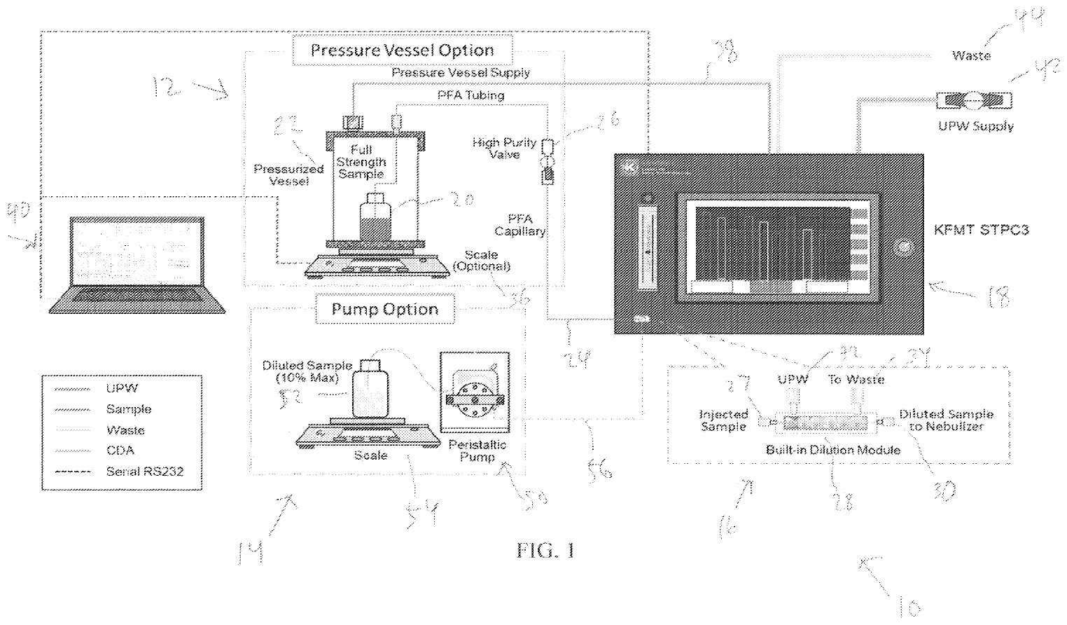

FIG. 1 shows an embodiment of the system 10 of the invention, whereby a sample can be obtained for measurement via a pressure vessel 12 or a pump 14, preferably a peristaltic pump. Both the pressure vessel 12 and pump 14 are communicatively connected to a dilution module 16, which is connected to an analyzer 18, such as a particle counter. In the instant example, the particle counter 18 is a scanning threshold particle counter, most preferably a STPC3 provided by Kanomax FMT. A Kanomax Liquid Nanoparticle Sizer may alternatively be used as the particle analyzer/detector. This arrangement may be used to monitor a variety of characteristics, including for example high purity water quality.

The pressure vessel section 12 comprises a sample container 20 disposed in a pressurized vessel 22. A scale 36 is optionally provided. The pressure vessel 12 is connected to the particle counter 18 via line 24, preferably through high purity valve 26.

The dilution module 16 has a sample input 27, a dilution section 28 and a diluted sample outlet 30, along with connections to diluent (for example, UPW) input 32 and waste 34. The analyzer 18 may include a nebulizer. The analyzer 18 is connected to the pressure vessel via a pressure supply line 38. The analyzer 18 is also connected to a system controller 40, diluent (UPW) supply 42, and waste 44.

The pump section 14 preferably comprises a peristaltic pump 50 connected to a sample container 52. A scale 54 is also preferably provided. The pump section 14 is connected to the dilution module 16 of the analyzer 18 via line 56.

For clarity, a list of elements, in this embodiment, shown interconnected in the drawings, of this system of the invention is as follows:

| | |
|---|---|
| 10 | On-line analytical chemical measurement system |
| 12 | Pressure Vessel Section |
| 14 | Pump Section |
| 16 | Dilution Module |
| 18 | Analyzer, Particle Counter, Scanning Threshold Particle |
| | Counter (STPC)-KFMT STPC3 |
| 20 | Sample container |
| 22 | Pressure Chamber (Vessel) |
| 24 | Pressure Section to Analyzer Connection line (PFA capillary) |
| 26 | High purity valve |
| 27 | Sample input |
| 28 | Dilution Section |
| 30 | Diluted Sample output |
| 32 | Diluent (UPW) input |
| 34 | STPC Waste Output |
| 36 | Scale |
| 38 | Pressure supply line |
| 40 | Controller |
| 42 | Diluent (UPW) supply |
| 44 | Waste output |
| 50 | Peristaltic pump |
| 52 | Sample container |
| 54 | Scale |
| 56 | Pump to analyzer line |

The pressure vessel section 12 is advantageous because it provides minimal contamination and measures chemicals at fill bottle strength. The pump section 14 has the advantages of easily switching samples and allowing a broad range of dilution ratios. It is limit however to the use of approximately 10% isopropyl alcohol (IPA) using known tubing materials.

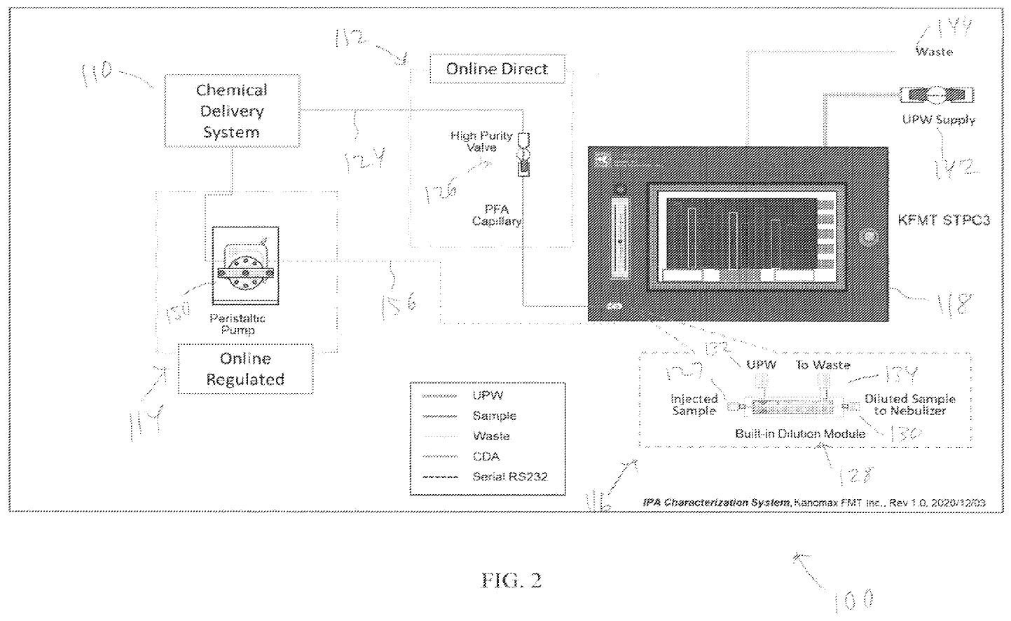

FIG. 2 shows an embodiment of the system 100 of the invention, whereby a sample can be obtained online directly or online regulated. Both the online direct section 112 and online regulated section 114 are both communicatively connected to a chemical delivery system 110 for input and output to a dilution module 116, which is connected to or part of an analyzer 118, such as a particle counter. In the instant example, the particle counter 118 is a scanning threshold particle counter, most preferably a STPC3 provided by Kanomax FMT. This arrangement may be used to monitor liquid quality and other characteristics of compounds.

The online direct section 112 comprises a direct line 124 between the chemical delivery system 110 and the analyzer 118. The line 124 is preferably a PFA capillary line. A high purity valve 26 is preferably connected along the line 124.

The dilution module 116 has a sample input 127, a dilution section 128 and a diluted sample outlet 130, along with connections to diluent (for example, UPW) input 132 and waste 134. The analyzer 118 may include a nebulizer. The analyzer 118 is also connected to a system controller (not shown), diluent (UPW) supply 142, and waste 144.

The online regulated section 114 preferably comprises a peristaltic pump 150 connected to the chemical delivery system 110. The pump 150 is connected to the dilution module 116 of the analyzer 118 via line 156.

For clarity, a list of elements, in this embodiment, shown interconnected in the drawings, of this system is as follows:

| | |
|---|---|
| 100 | Online Direct and Regulated System |
| 110 | Chemical Delivery System |
| 112 | Direct Section |
| 114 | Regulated Section |
| 116 | Dilution Module |
| 118 | Analyzer, Particle Counter, Scanning Threshold Particle |
| | Counter (STPC)-KFMT STPC3 |
| 124 | Direct Section to Analyzer Connection line (PFA capillary) |
| 126 | High purity valve |
| 127 | Sample input |
| 128 | Dilution Section |
| 130 | Diluted Sample output |
| 132 | Diluent (UPW) input |
| 134 | STPC Waste Output |
| 142 | Diluent (UPW) supply |
| 144 | Waste output |
| 150 | Peristaltic pump |
| 156 | Regulated Section to analyzer line |

The online direct (capillary) section 112 is advantageous because it provides the easiest and most direct solution. It does however require stable chemical pressure. Unstable pressure may cause fluctuation in readings. The online regulated (flow or pressure) section 114 has the advantages of providing stable chemical flow (stable UPW dilution ratio), it can be combined with capillary (direct) function, and it can use a pump, valve, or pressure regulator. It may however introduce background contamination.

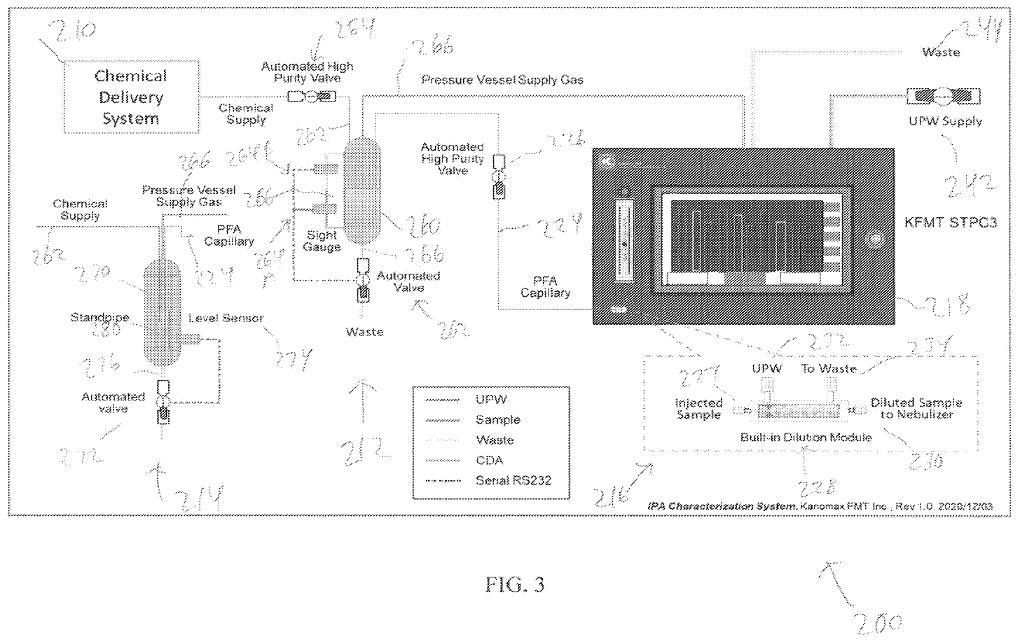

FIG. 3 shows an embodiment of the system 200 of the invention, whereby an online chamber can be operated in both batch and continuous modes. Both the online batch section 212 and online continuous section 214 are both communicatively connected to a chemical delivery system 210 for input and output to a dilution module 216, which is connected to or part of an analyzer 218, such as a particle counter. In the instant example, the particle counter 218 is a scanning threshold particle counter, most preferably a STPC3 provided by Kanomax FMT. This arrangement may be used to monitor liquid quality and other characteristics of compounds.

The online batch section 112 comprises a pressure chamber 260 with an input line 262 connected to the chemical delivery system 210 through a first automated high purity valve 264. The chamber 260 preferably has an elongated, vertically oriented configuration. The open end of output line 224 is disposed a predetermined depth in the chamber 210 interior. Output line 224 is connected to the dilution module 216 that is connected to or part of the analyzer 218 through a second automated high purity valve 226. The line 224 is preferably a PFA capillary line. Waste line 266 connected to the bottom end of the chamber 260 is connected to an automated waste valve 262. One or more sight gauges 264 A and B are connected to line 266. Pressure gas supply line 226 extends from the analyzer 218 to the top of chamber 260.

The dilution module 216 has a sample input 227 (connected to line 224), a dilution section 228 and a diluted sample outlet 230, along with connections to diluent (for example, UPW) input 232 and waste 234. The analyzer 218 may include a nebulizer. The analyzer 218 is also connected to a system controller (not shown), diluent (UPW) supply 242, and waste 244.

The online continuous section 214 comprises a pressure chamber 270 with an input line 262 connected directly to the chemical delivery system 210. The chamber 270 also preferably has an elongated, vertically oriented configuration. Standpipe 280 is disposed within the chamber 270. The open end of output line 224 is disposed a predetermined depth in the standpipe 280. Output line 224 is connected to the dilution module 216 that is connected directly to the dilution module 216 (without the need for a valve) that is connected to or part of the analyzer 218. The line 224 is preferably a PFA capillary line. Waste line 276 connected to the bottom end of the chamber 270 is connected to an automated waste valve 272. A level sensor 274 is connected to the chamber 270 at a predetermined position. Pressure gas supply line 226 extends from the analyzer 218 to the top of chamber 270.

For clarity, a list of elements, in this embodiment, shown interconnected in the drawings, of this system is as follows:

| | |
|---|---|
| 200 | Online Batch and Continuous System |
| 210 | Chemical Delivery System |
| 212 | Batch Section |
| 214 | Continuous Section |
| 216 | Dilution Module |
| 218 | Analyzer, Particle Counter, Scanning Threshold Particle |
| | Counter (STPC)-KFMT STPC3 |
| 224 | Batch/Continuous Section to Analyzer Connection line |
| | (PFA capillary) |
| 226 | High purity valve |
| 227 | Sample input |
| 228 | Dilution Section |
| 230 | Diluted Sample output |
| 232 | Diluent (UPW) input |
| 234 | STPC Waste Output |
| 242 | Diluent (UPW) Supply |
| 244 | Waste Output |
| 260 | Batch Online Pressure Tank |
| 262 | Waste Valve |
| 264 | Sight Gauges A, B |
| 266 | Gauge Line |
| 270 | Continuous Online Pressure Tank |
| 272 | Waste Valve |
| 274 | Level Sensor |
| 280 | Standpipe |

The online batch section 212 is advantageous because it has a small chamber that fills and drains on a regular cycle, it is automated (although not in real time). However, it requires the high purity valves which may introduce contamination. The online continuous section 214 has the advantages of chemical continuously flowing into its standpipe and its function is not subject to chemical pressure variations. However, it may produce relatively higher chemical waste.

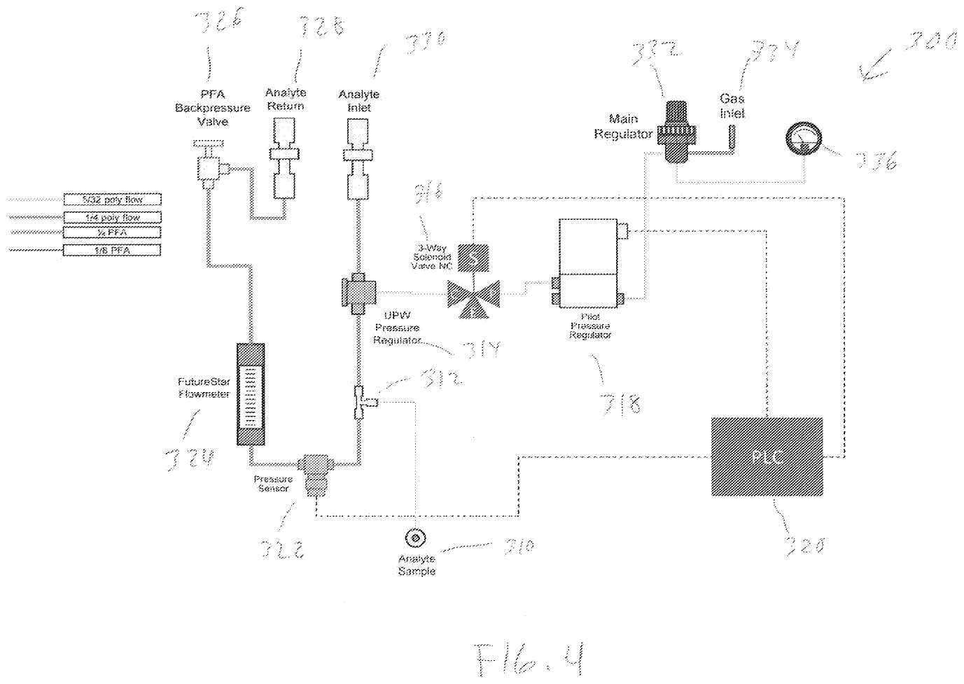

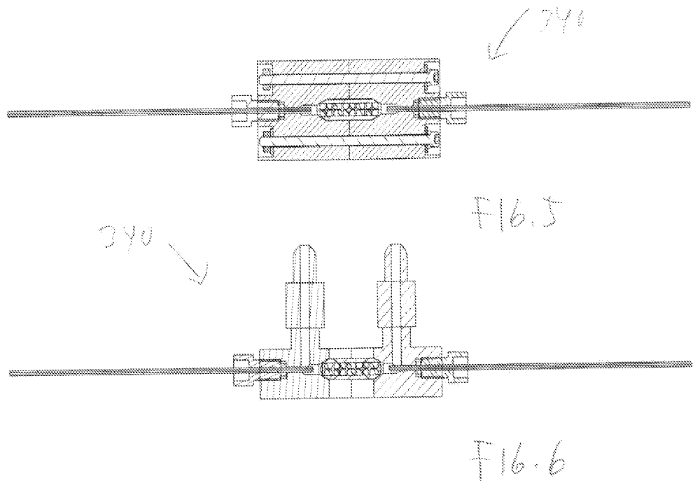

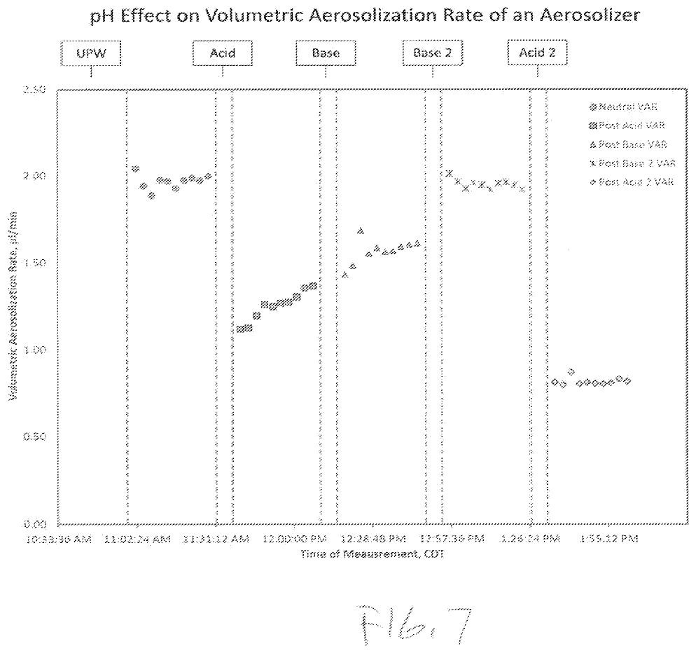

FIG. 4 is a schematic diagram of an embodiment of an IPA sample delivery arrangement including an embodiment of a pressure conditioner. FIG. 5 is a first longitudinal crossectional view of an embodiment of an NPN mixer which is useful in the system and apparatus of the invention. FIG. 6 is a second longitudinal crossectional view of the NPN mixer.

For clarity, a list of elements, in this embodiment, shown interconnected in the drawings, of this system is as follows:

| | |
|---|---|
| 300 | Sample Delivery System with Pressure Conditioning |
| 310 | Analyte Sample |
| 312 | In line connector |
| 314 | Ultra Pure Water Regulator |
| 316 | 3 Way Solenoid Valve |
| 318 | Pilot Pressure Regulator |
| 320 | Program Logic Controller (PLC) |
| 322 | Pressure Sensor |
| 224 | Flow Meter (Future Star) |
| 226 | PFA Back Pressure Valve |
| 328 | Analyte Return |
| 330 | Analyte Inlet |
| 332 | Main Regulator |
| 334 | Gas Inlet |
| 336 | Indicator |
| 338 | Intentionally Left Blank |
| 340 | NPN Mixer |

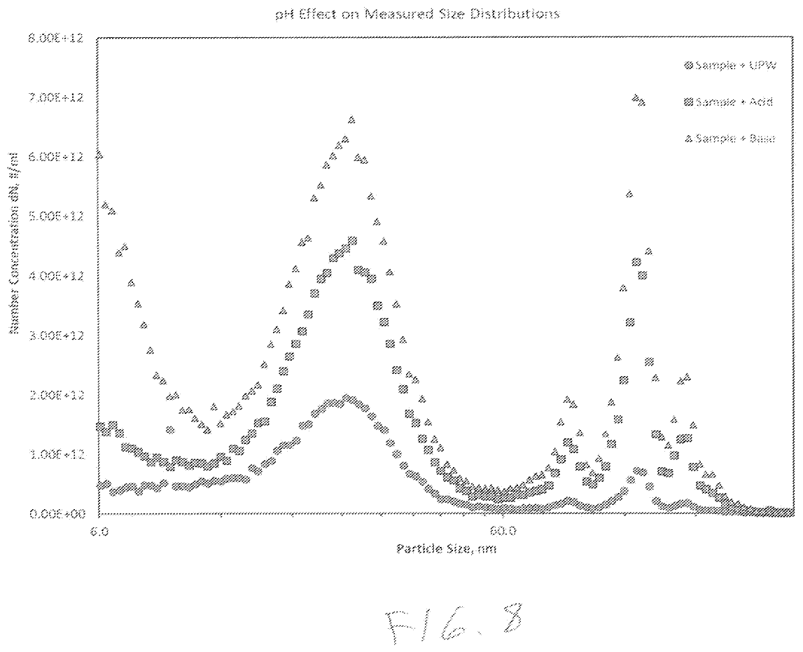

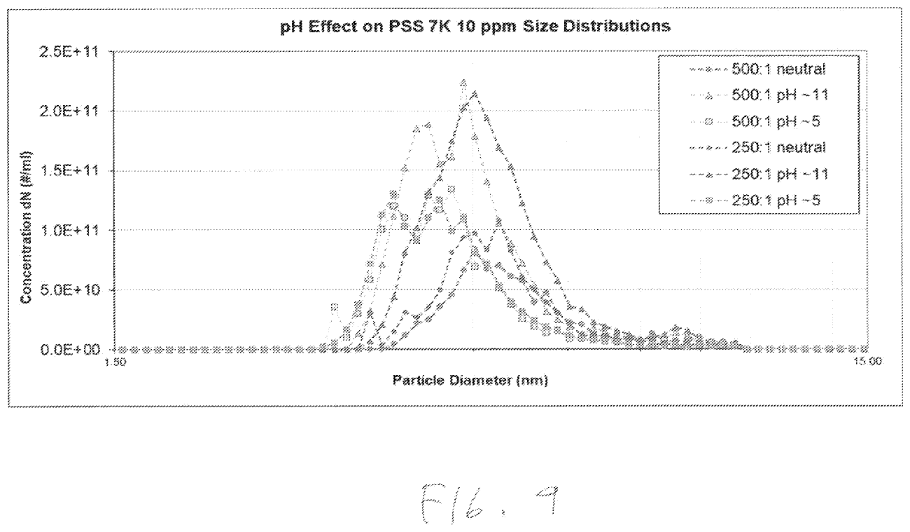

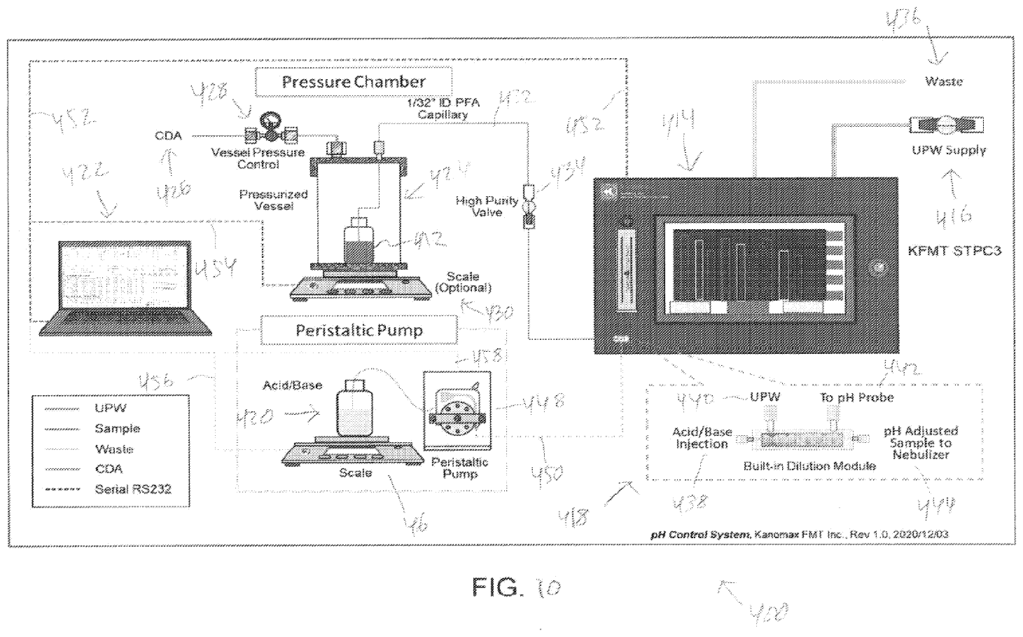

FIG. 7 is graph showing the effect of pH on the volumetric aerosolization rate of an aerosolizer. FIG. 8 is a graph showing the effect of pH on measure size distributions. FIG. 9 is a graph showing the effect of pH on particle sizing systems size distributions.

2. System and Method for Controlling pH of Liquids Used to Dilute Colloidal Particle Samples

The invention secondly provides an on-line analytical system, apparatus and method for measurement of particle size distribution, particle number concentration, and other properties of colloids, that permits control the pH of diluent (to control the pH of the diluted sample) used in the system, apparatus and method. In particular, the system permits improved control of the pH of Ultra Pure Water (UPW) used for dilution of the colloidal samples. One advantage of the system is that it enables measurement of samples that are strongly affected by pH of a carrier liquid. The system also allows for adjustment of pH to remove precipitates in tubing and other “wet” components in analytical instrumentation.

Analytical instrumentation used for the measurement of colloid properties (e.g. particle size distribution and number concentration) often requires sample dilution prior to analysis. The dilution may be completed either manually, on-line, or by a combination of the two. On-line dilution is used to minimize the introduction of dissolved non-volatile residue or other contaminants that could affect the quality of the measurement. On-line dilution also reduces the time a sample is at kept at a reduced concentration, which can lead to changes in the sample properties.

The dilution step can significantly change the pH of the sample leading to coagulation, fragmentation, or precipitation. By controlling the pH of the diluent, these effects can be mitigated.

The sample diluent is typically Ultrapure Water (UPW). Its pH is adjusted by introducing volatile acids/bases upstream of the sample introduction module (not shown). The acids/bases may be liquids such as, ammonium hydroxide, hydrochloric acid, or the like. The acids/bases are introduced via a dilution/mixer or pressurized vessel, or gases such as Carbon Dioxide. Ammonia, or the like. The gases are introduced via diffusive membranes. The pH level can be controlled by varying the acid/base liquid flowrate or gas concentration. The sample is introduced downstream of the pH controlled diluent.

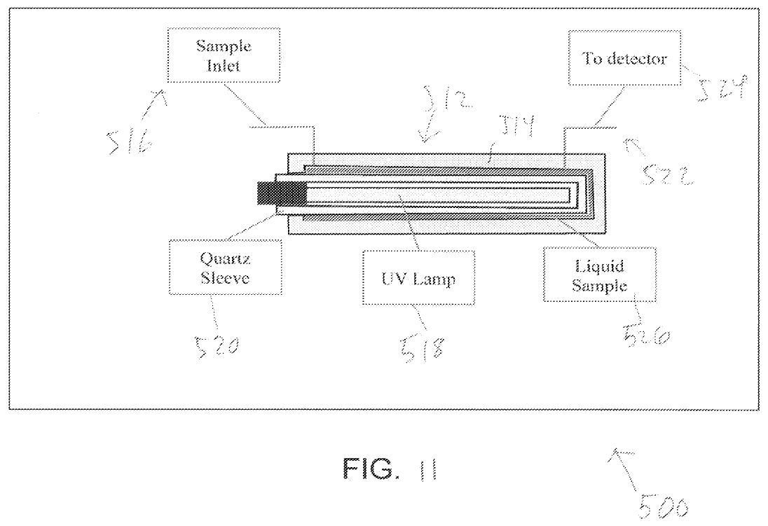

FIG. 10 shows an embodiment of this system 400. The system 400 primarily comprises a sample input 412 connected to a particle counter 414 having an Ultra Pure Water (UPW) supply 416 and an interconnected dilution module 418, an acid/base supply connected to the dilution module 418, and a control system 422. The particle counter is preferably a Scanning Threshold Particle Counter for monitoring ultrapure liquid quality, most preferably an STPC3 Particle Counter provided by Kanomax FMT.

A list of elements, in this embodiment, shown interconnected in the drawings, of this system is as follows:

| | |
|---|---|
| 400 | On-line analytical particle measurement system |
| 412 | Sample |
| 414 | Scanning Threshold Particle Counter (STPC)-KFMT STPC3 |
| 416 | Ultra Pure Water (UPW) Supply |
| 418 | Dilution Module |
| 420 | Acid/Base Supply |
| 422 | Controller |
| 424 | Pressure Chamber (Vessel) |
| 426 | Clean Dry Air (CDA) Supply |
| 428 | Vessel Pressure Control |
| 430 | Scale for Sample (Optional) |
| 432 | Sample Output Line (Capillary) |
| 434 | High Purity Valve |
| 436 | STPC Waste Output |
| 438 | Acid/Base Injection Input |
| 440 | UPW Input |
| 442 | pH Probe Input |
| 444 | pH Adjusted Sample Output to Nebulizer of STPC |
| 446 | Scale for Acid/Base |
| 448 | Pump (Peristaltic) |
| 450 | Acid/Base Output Line |
| 452 | Controller Communicative Connection To STPC (Serial) |
| 454 | Controller Connection To Sample Chamber |
| 456 | Controller Connection To Acid/Base Weight |
| 358 | Controller Connection To Acid/Base Pump |
| 360 | Intentionally Left Blank |

3. Method and System for Measuring Net Contribution of High Molecular Weight Organic Particles on Total Particles in High Purity Liquids.

The invention thirdly provides a system, apparatus and method of measuring the concentration of particles and particle precursors in a high purity liquid. The system facilitates the ability to discriminate between particles composed of High Molecular Weight Organic (HMWO) material and inorganic material.

Measurement and control of particles in high purity liquids is a significant issue in many processes, particularly semiconductor manufacture. Source appointment of these particles is necessary for development of mitigation strategies. A significant source of particles in Ultra Pure Water (UPW) is from breakdown of organic materials used in filtration systems. Examples of subject filtration system elements include plastic tubing and ion-exchange resins. Particles composed of HMWO material often have low volatility, making them resistant to removal through heat treatment of a cleaned surface. These particles also reach a size that can affect the performance of semiconductor circuits. While there are established methods for measuring total organic carbon in high purity water systems, these methods do not discriminate between Low Molecular Weight Organic (LMWO) and HMWO particles, and particle precursors.

In a preferred embodiment of this method, a liquid sample is introduced to a module that decomposes HMWO particles to fragments or individual molecules. Methods for decomposing HMWO include exposure to Ultraviolet Radiation, the use of Oxidizing/Reducing chemicals, and/or exposure to High Temperature. By switching the decomposition apparatus on and off, the contribution of HMWO particles on the detector signal can be realized through the net difference in counted particles.

The sample inlet may be connected to a sample introduction/dilution module that may be used to challenge the device with known HMWO to verify decomposition performance.

FIG. 11 shows an embodiment of this system 500. A liquid sample 524 is fed to a processing module 512 comprising a housing 514 having a sample inlet 516, an ultraviolet lamp 518, a quartz sleeve 520 and an outlet 522 which is communicatively coupled to a particle detector.

A list of elements in this embodiment, shown interconnected in the drawings, of this system is as follows:

| | |
|---|---|
| 500 | HMWO Particle Measurement System |
| 512 | Decomposition Module |
| 514 | Housing |
| 516 | Sample Inlet |
| 518 | UV Lamp |
| 520 | Quartz Sleeve |
| 522 | Outlet |
| 524 | Detector |
| 526 | Liquid |
| S28 | Intentionally Left Blank |

Although the systems, apparatus, and methods of the invention have been described in connection with the field of chemical measurement and analysis, it can readily be appreciated that the invention is not limited solely to such fields, and can be used in other fields.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used tor distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

Although the invention or elements thereof may by described in terms of vertical, horizontal, transverse (lateral), longitudinal, and the like, it should be understood that variations from the absolute vertical, horizontal, transverse, and longitudinal are also deemed to be within the scope of the invention.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time. e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein. “approximately” can, in some embodiments, mean within plus or minus ten percent of the stated value. In other embodiments, “approximately” can mean within plus or minus five percent of the stated value. In further embodiments. “approximately” can mean within plus or minus three percent of the stated value. In yet other embodiments, “approximately” can mean within plus or minus one percent of the stated value.

The embodiments above are chosen, described and illustrated so that persons skilled in the art will be able to understand the invention and the manner and process of making and using it. The descriptions and the accompanying drawings should be interpreted in the illustrative and not the exhaustive or limited sense. The invention is not intended to be limited to the exact forms disclosed. While the application attempts to disclose all of the embodiments of the invention that are reasonably foreseeable, there may be unforeseeable insubstantial modifications that remain as equivalents. It should be understood by persons skilled in the art that there may be other embodiments than those disclosed which fall within the scope of the invention as defined by the claims. Where a claim, if any, is expressed as a means or step for performing a specified function it is intended that such claim be construed to cover the corresponding structure, material, or acts described in the specification and equivalents thereof, including both structural equivalents and equivalent structures, material-based equivalents and equivalent materials, and act-based equivalents and equivalent acts.

The invention claimed is:

1. A method for conditioning an analyte for measurement, comprising the steps of:
providing an analyte;
collecting a sample of the analyte;
conditioning the sample of analyte; and
supplying the conditioned analyte to an analytical apparatus.

2. The method of claim 1, wherein the analyte includes a liquid and is provided in a reservoir.

3. The method of claim 2, wherein the reservoir is continuously weighed, and weight data is communicated to the analytical apparatus.

4. The method of claim 2, wherein the analyte is collected from the reservoir by pumping analyte from the reservoir.

5. The method of claim 2, wherein the analyte is collected from the reservoir by pressurizing the reservoir whereby the analyte flows from the reservoir.

6. The method of claim 5, further comprising the step of introducing a secondary fluid to the reservoir.

7. The method of claim 4 or 5, wherein the step of conditioning includes regulating pressure of the analyte to a predetermined value.

8. The method of claim 4 or 5, wherein the step of conditioning includes regulating volumetric flow of the analyte to a predetermined value.

9. The method of claim 7 or 8, further comprising the step of restricting flow of the analyte.

10. The method of claim 4 or 5, wherein the step of conditioning includes diluting the analyte.

11. The method of claim 4 or 5, wherein the step of conditioning includes regulating the temperature of the analyte.

12. The method of any one of claims 4-11 wherein conditioning is modulated.

13. The method of claim 4 or 5, wherein the step of conditioning includes discarding a portion of the analyte prior to supplying the conditioned analyte to an analytical apparatus.

14. The method of claim 1, wherein the analytical apparatus analyzes the analyte by counting particles in the analyte.

15. The method of any one of claims 1-13, wherein the analytical apparatus is calibrated using information from the collecting or conditioning steps.

16. An apparatus for conditioning an analyte for measurement by analytical instrumentation, comprising
a reservoir for receiving and holding an analyte;
an analyte collector communicatively connected to the reservoir;
an analyte conditioner communicatively connected to the analyte collector; and
an analytical apparatus communicatively connected to the analyte conditioner.

17. The apparatus of claim 16, wherein the analyte collector is a pump.

18. The apparatus of claim 16, wherein the analyte collector is a pressure vessel.

19. The apparatus of claim 18, further comprising means to introduce a secondary fluid into the pressure vessel.

20. The apparatus of claim 16, wherein the analyte conditioner is a pressure regulator.

21. The apparatus of claim 16, wherein the analyte conditioner is a volumetric flow regulator.

22. The apparatus of claim 20 or 21 is a flow restrictor.

23. The apparatus of claim 16, wherein the analyte conditioner is a dilution module.

24. The apparatus of claim 16, wherein the analyte conditioner is a heater or cooler.

25. The apparatus of claim 16, wherein the analytical apparatus is a particle counter.
